(19) United States
(12) Patent Application Publication
(10) Pub. No.: US 2019/0265959 A1
(43) Pub. Date: Aug. 29, 2019

(54) AUTOMATICALLY SYNCHRONIZING THE INSTALL AND BUILD DIRECTORIES OF A SOFTWARE APPLICATION

(71) Applicant: Microsoft Technology Licensing, LLC, Redmond, WA (US)

(72) Inventor: Jason Ghssane SALAMEH, Bothell, WA (US)

(21) Appl. No.: 15/904,215

(22) Filed: Feb. 23, 2018

(51) Int. Cl. G06F 8/61

(52) U.S. Cl. CPC G06F 8/61

(57) ABSTRACT

Techniques for automatically synchronizing the install and build directories of a software application are provided. According to one set of embodiments, a computer system can, at a time of installing the application, extract an intent file from a software package comprising at least one file of the application, where the intent file includes a mapping that identifies a first location for the file with respect to a build directory of a development environment where the application was developed and a second location for the file with respect to an install directory of the computer system where the application will be, or has been, installed. If the first location is different from the second location, the computer system can create a hard link for the file at the first location within the install directory that points to an instance of the file residing at the second location within the install directory.

### BACKGROUND

During the development of a software application, a developer typically writes and debugs code for the application in the context of a build directory that resides on the developer's machine or some other storage location that is accessible to the developer. This build directory defines the hierarchical organization of the application's files and the location of each such file relative to the application executable file(s) (e.g., .exe file(s), .dll file(s), etc.) in the development environment. For example, the build directory may include a main application executable in a “main” subdirectory, asset files in an “assets” subdirectory under the “main” subdirectory (i.e., “main\assets”), configuration files in a “config” subdirectory, and so on.

When development of the application is complete, a builder (who may or may not be the same as the developer) takes all of the application's files from the build directory and packages them into one or more installable software packages. These packages are then made available to end-users via one or more distribution channels (e.g., an online store, physical media, etc.) for installation on their machines.

In some cases, the packaging process can cause the hierarchical organization of the application's files as installed on an end-user's machine—in other words, the application's install directory—to differ from the build directory in the development environment. In scenarios where the builder and the developer are one in the same (i.e., the same individual), the developer will be directly aware of this and can make appropriate changes to the application executable(s) so that the executable(s) can correctly find the application's files within the install directory at runtime.

However, in scenarios wherein the builder and the developer are different individuals or the builder is an automated agent, the developer generally will not have direct knowledge of packaging decisions made by the builder that result in a divergence between the install and build directories. This means that the builder and the developer must closely coordinate their activities in order to ensure that the application will run properly once installed on end-user machines. This coordination can be time-consuming and burdensome, particularly if the application is updated and re-distributed on a frequent basis.

### SUMMARY

Techniques for automatically synchronizing the install and build directories of a software application are provided. According to one set of embodiments, a computer system can, at a time of installing the application, extract an intent file from a software package comprising at least one file of the application, where the intent file includes a mapping that identifies a first location for the file with respect a build directory of a development environment where the application was developed and a second location for the file with respect to an install directory of the computer system where the application will be, or has been, installed. If the first location is different from the second location, the computer system can create a hard link for the file at the first location within the install directory that points to an instance of the file residing at the second location within the install directory.

### BRIEF DESCRIPTION OF THE DRAWINGS

FIG. 1 depicts a simplified block diagram of a conventional system environment.

FIG. 2 depicts an example application development/packaging/installation scenario.

FIG. 3 depicts a simplified block diagram of system environment according to certain embodiments.

FIG. 4 depicts an example intent file according to certain embodiments.

FIG. 5 depicts the install directory of FIG. 2 modified in accordance with the intent file of FIG. 4 according to certain embodiments.

FIG. 6 depicts an application packaging workflow according to certain embodiments.

FIG. 7 depicts an application installation workflow according to certain embodiments.

FIG. 8 depicts a simplified block diagram of a computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof

### 1. Overview

Embodiments of the present disclosure provide techniques for automatically synchronizing the directory structure of a software application as installed on an end-user machine (i.e., the application's install directory) with the directory structure of the application as maintained in a development environment (i.e., the application's build directory). With these techniques, there is no need for the application developer to be aware of how the packaging process carried out by the application builder may change the application's installed file hierarchy; instead, the application developer can simply write his/her code with the assumption that all of the application's files will be located in the same relative locations in the install directory as in the build directory. If the packaging process causes a particular file to move to a different location once the application is installed on an end-user's machine (e.g., from subdirectory “A” in the build directory to subdirectory “B” in the install directory), the techniques described herein can automatically create, in the install directory, a hard link at the old location/file path of the file (as it existed in the build directory) which points to the new location of the file in the install directory. In this way, the application executable(s) can correctly find and access the file via the hard link, even though the file has moved to a different location post-installation.

The foregoing and other aspects of the present disclosure are described in further detail in the sections that follow.

### 2. System Environment

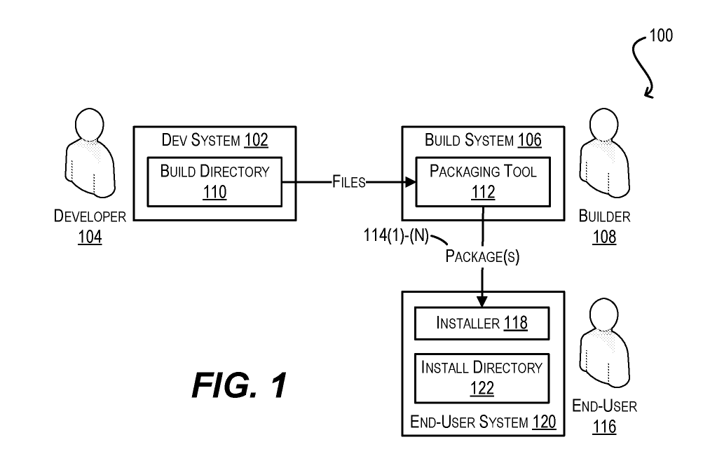

To provide context for the embodiments described herein, FIG. 1 depicts a conventional application development/build environment 100 comprising a development system 102 operated by a developer 104 and a build system 106 operated by a builder 108. Although systems 102 and 106 are shown as two separate systems, in some cases the functionalities of systems 102 and 106 may be combined into a single system. Further, although developer 104 and builder 108 are shown as two separate individuals or agents, in some cases the actions performed by developer 104 and builder 108 may be carried out by a single individual/agent.

As depicted in FIG. 1, at the time of developing a software application, developer 104 typically creates a build directory 110 on development system 102 that defines the hierarchical organization of files that make up the application. Developer 104 writes and tests his/her code against this build directory structure; for example, if the application executable needs to access the file “level1.txt” as part of its runtime operation and developer 104 knows that this file reside in a “levels” subdirectory under build directory 110, developer 104 will program the executable to specifically look for this file in the “levels” subdirectory.

Upon completing development of the application, developer 104 notifies builder 108. In response, builder 108 uses a packaging tool 112 to ingest the file contents/hierarchy of build directory 110 and, based on a number of packaging rules or decisions made by builder 108, generate one or more installable software packages 114(1)-(N) for the application. For instance, builder 108 may determine that the application executable and core libraries should be placed into one package, a first subset of the application's assets should be placed into another package, a second subset of the application's assets should be placed into yet another package, etc.

Finally, software packages 114(1)-(N) are made available to an end-user 116, who can install the packages (and thus, the application) via an installer program 118 onto his/her system 120. The end result of this installation process is the creation of an install directory 122 on end-user system 120 that includes the installed files of the application.

As noted in the Background section, one complication with the development and packaging workflow described above is that, in some cases, the packaging decisions made by builder 108 can change the location of certain application files in install directory 122 relative to build directory 110. This, in turn, can cause the application to break once installed on end-user system 120 (if the changes are not accounted for in the application code).

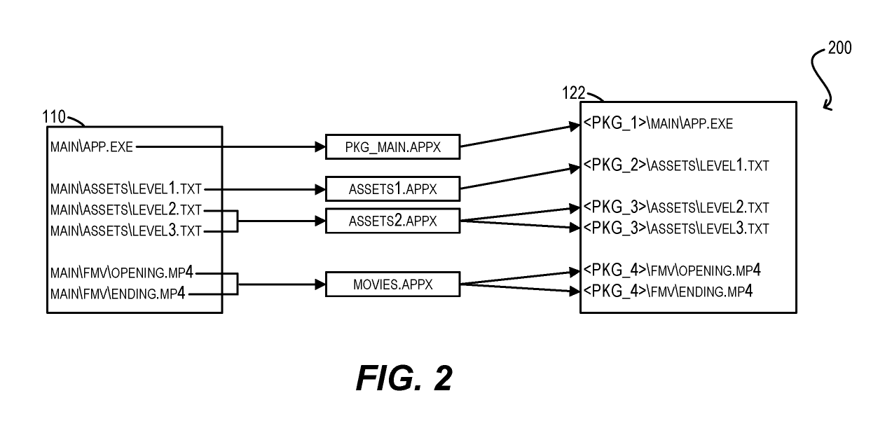

To better understand this complication, consider example scenario 200 depicted in FIG. 2. In scenario 200, build directory 110 includes, among other things, a “main” subdirectory comprising one file “app.exe,” a “main\assets” subdirectory comprising three files “level1.txt,” “level2.txt,” and “level3.txt,” and a “main\fmv” subdirectory comprising two files “opening.mp4” and “ending.mp4.”

As part of the packaging process carried out by builder 108, “app.exe” is packaged into a first software package (in this example an APPX package, although other types of packages are also possible) named “pkg_main.appx.” Further, “level1.txt” is packaged into a second software package named “assets1.appx”; “level2.txt” and “level3.txt” are packaged into a third software package named “assets2.appx”; and “opening.mp4” and “ending.mp4” are packaged into a fourth software package named “movies.appx.”

Due to the nature of the APPX packaging model, this packaging configuration results in an install directory on end-user system 120 where the “assets” and “fmv” subdirectories are no longer children of the “main” subdirectory; rather, as shown in FIG. 2, the “assets” and “fmv” subdirectories become peer directories of “main” in install directory 122, which can cause numerous problems. For example, if “app.exe” is written to assume that “level1.txt” is in “main\assets” (as it is in build directory 110), the code for accessing this file will necessarily break once the application is installed on end-user system 120.

It is possible to mitigate these problems by having developer 104 modify his/her code accordingly to account for the new locations of files in install directory 122. However, as mentioned previously, if developer 104 and builder 108 are different individuals, this mitigation requires close coordination between the individuals, which can be time-consuming and burdensome. Further, even in scenarios where developer 104 and builder 108 are one in the same, it would be preferable for developer 104 to not have to worry about how his/her packaging decisions may impact the application code.

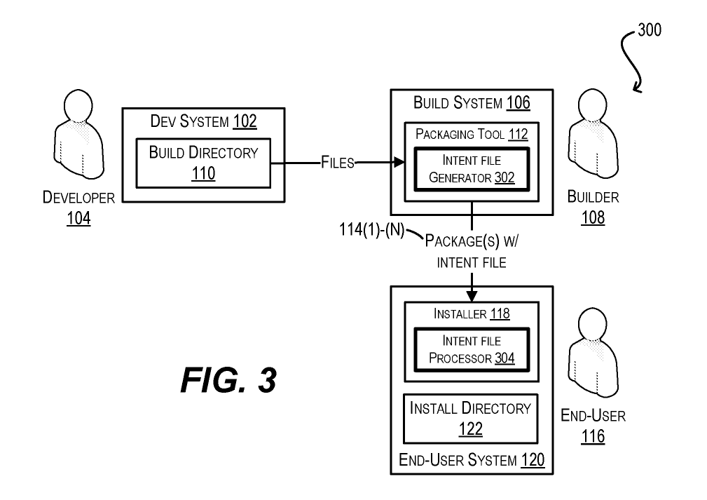

To address the foregoing and other similar issues, FIG. 3 depicts an enhanced version of the system environment of FIG. 1 (shown as environment 300) that includes a novel intent file generator 302 in packaging tool 112 of build system 106 and a novel intent file processor 304 in installer 118 of end-user system 120. Components 302 and 304 may be implemented in software, hardware, or a combination thereof.

At a high level, intent file generator 302 can, at the time builder 108 uses packaging tool 112 to generate software packages 114(1)-(N), create an “intent file” that includes, for each file in build directory 110, a mapping between the location (i.e., file path) of that file as it exists in build directory 110 and the location (file path) of that file as it will exist in install directory 122. These mappings will largely depend on how builder 108 decides to partition the files in build directory 110 across packages 114(1)-(N), since this partitioning will control how the files will be laid out in install directory 122. Upon creating the intent file, intent file generator 302 can include the intent file in one or more of packages 114(1)-(N) (or in an aggregated bundle of these packages, such as an APPX bundle).

Then, when end-user 116 installs packages 114(1)-(N) on his/her system 120 via installer 118, intent file processor 304 can extract the intent file and, for each mapping therein, determine whether the “old” location of the application file corresponding to that mapping (i.e., the relative location in build directory 110) is different from the “new” location of the application file (i.e., the relative location in install directory 122). If so, intent file processor 304 can create, in install directory 122, a hard link at the old location that points to the file at the new location. As known in computing, a hard link is a file system entry that associates a name (i.e., the name of the hard link) with an actual file in the file system. In this manner, intent file processor 304 can automatically synchronize the structure of install directory 122 with the structure of build directory 110 and enable the application executable to access all of the files of the application at the relative locations they reside at in build directory 110, even though they may have been moved to different locations within install directory 122.

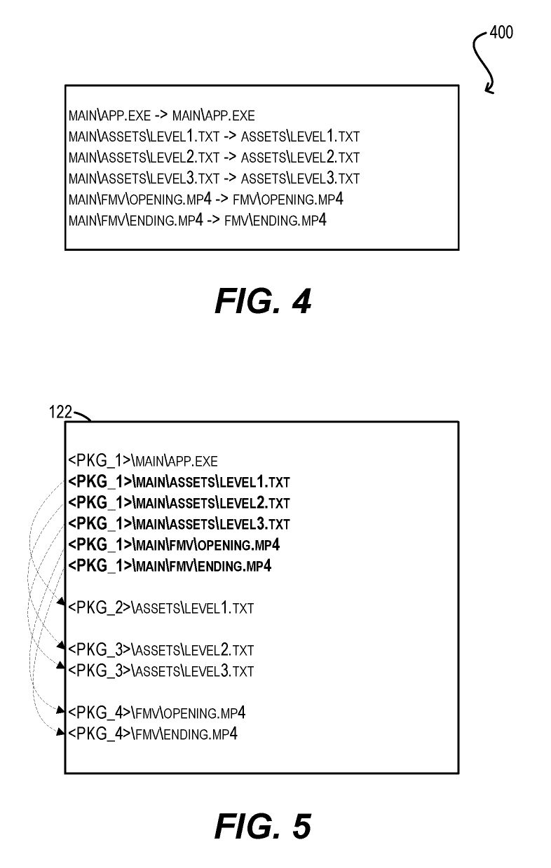

To illustrate the foregoing, FIG. 4 depicts an example intent file 400 that includes mappings for the application files shown in scenario 200 of FIG. 2. In addition, FIG. 5 depicts a version of the install directory from FIG. 2 that has been modified to incorporate hard links per the mappings of intent file 400. As shown in FIG. 5, five hard links (highlighted in bold) are created in install directory 122 under the “<PKG_1>\main\” directory: (1) a first hard link “assets\level1.txt” which corresponds to “main\assets\level1.txt” in build directory 110 and points to actual file “<PKG_2>\assets\level1.txt” in install directory 122; (2) a second hard link “assets\level2.txt” which corresponds to “main\assets\level2.txt” in build directory 110 and points to actual file “<PKG_3>\assets\level2.txt” in install directory 122; (3) a third hard link “assets\level3.txt” which corresponds to “main\assets\level3.txt” in build directory 110 and points to actual file “<PKG_3>\assets\level3.txt” in install directory 122; (4) a fourth hard link “fmv\opening.mp4” which corresponds to “main\fmv\opening.mp4” in build directory 110 and points to actual file “<PKG_4>\fmv\opening.mp4” in install directory 122; and (5) a fifth hard link “fmv\ending.mp4” which corresponds to “main\fmv\ending.mp4” in build directory 110 and points to actual file “<PKG_4>\fmv\ending.mp4” in install directory 122.

With the general architecture and approach described above, a number of advantages are realized. First, in scenarios where developer 104 and builder 108 are different individuals, there is no need for these two individuals to stay in sync regarding the packaging decisions made by builder 108 and how those decisions may change the installed file layout of the application. This can save a significant amount of time and effort, particularly if the application is iterated on and updated frequently.

Second, even in cases where developer 104 also packages the application, developer 104 does not need modify any code or make other changes to the application to account for packaging decisions that change the installed locations of files. Instead, developer 104 can simply rely on components 302 and 304 to automatically synchronize the directory structure of install directory 122 with build directory 110, thereby reducing the amount of work for the developer.

It should be appreciated that the system diagram shown in FIG. 3 is illustrative and not intended to limit embodiments of the present disclosure. For example, the various entities shown in this figure may be arranged according to different configurations or may include subcomponents or functions that are not specifically described. One of ordinary skill in the art will recognize other variations, modifications, and alternatives.

### 3. Packaging Workflow

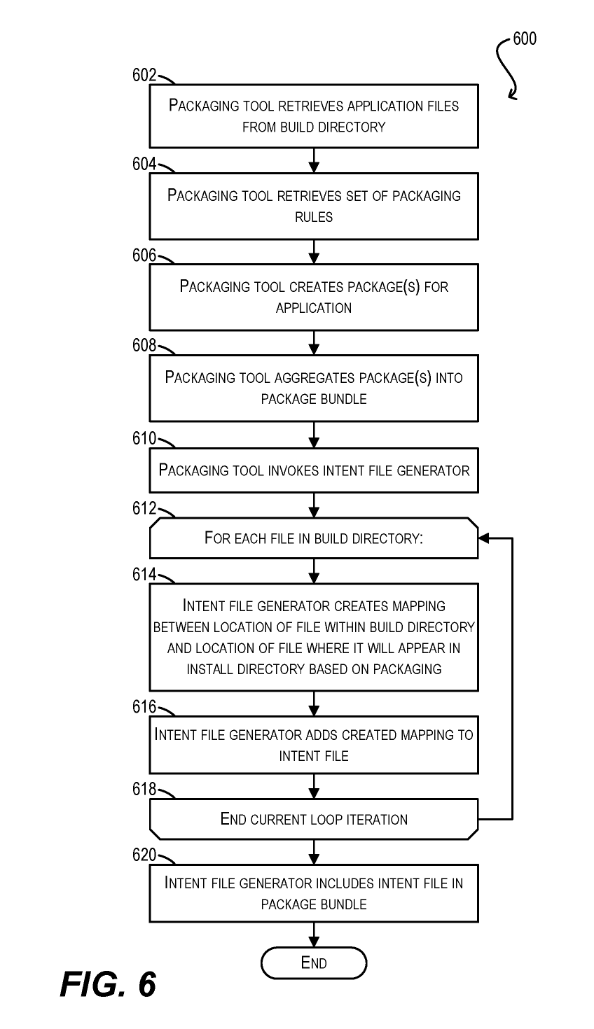

FIG. 6 depicts a workflow 600 of the processing that may be performed by packaging tool 112 and intent file generator 302 at the time builder 108 packages an application according to certain embodiments.

Starting with blocks 602 and 604, packaging tool 112 can retrieve the files of the application from build directory 110 of development system 102 and a set of packaging rules defined by, e.g., builder 108. The packaging rules can specify how the files in build directory 110 should be partitioned into packages 114(1)-(N) (e.g., files F1 and F2 go in to package P1, file F3 goes in to package P2, etc.). Based on these rules, packaging tool 112 can create packages 114(1)-(N) (block 606) and optionally aggregate packages 114(1)-(N) into a package bundle (block 608).

At block 610, packaging tool 112 can invoke intent file generator 302 to generate an intent file for the application. In response, intent file generator 302 can enter a loop for each application file in build directory 110 (block 612) and, within this loop, create a mapping between the location of the application file within build directory 110 and the location of the application file where it will appear once installed on an end-user system (i.e., within install directory 122) (block 614). In one set of embodiments, intent file generator 302 can determine this mapping based on the packaging rules retrieved at block 604. In other embodiments, intent file generator 302 can determine this mapping based on information manually defined/provided by builder 108.

Once created, intent file generator 302 can add the mapping to the intent file (block 616) and reach the end of the current loop iteration (block 618). Intent file generator 302 can then repeat loop 612 until all of the files in build directory 110 have been processed. Finally, at block 620, intent file generator 302 can add the intent file to the package bundle created at block 608 and workflow 600 can end.

### 4. Installation Workflow

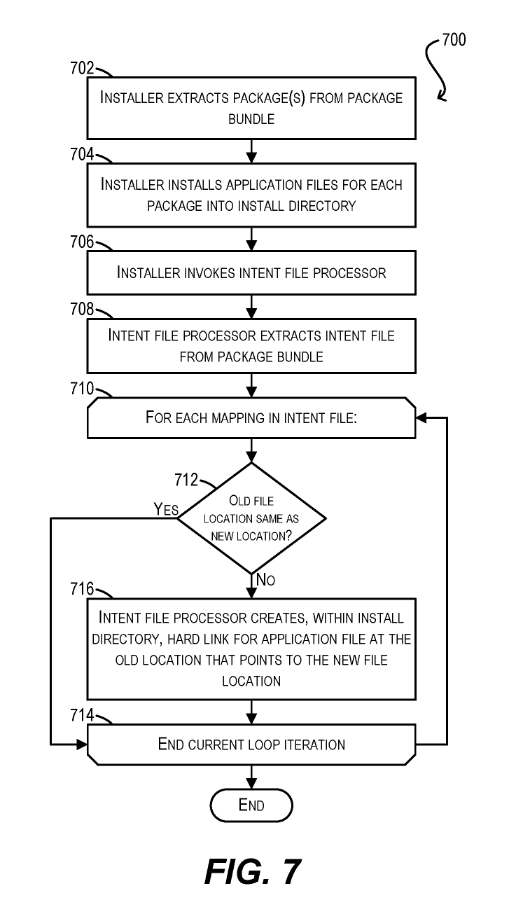

FIG. 7 depicts a workflow 700 of the processing that may be performed by installer 118 and intent file processor 304 at the time end-user 116 installs an application on his/her end-user system 120 according to certain embodiments. Workflow 700 assumes that the application has been packaged into a package bundle in accordance with workflow 600 of FIG. 6.

At blocks 702 and 704, installer 118 can first extract the various packages 114(1)-(N) included in the package bundle and can install the files for each package 114 at appropriate locations (e.g., subdirectories) within install directory 122 of system 120.

Once the packages have been installed, installer 118 can invoke intent file processor 304 (block 706). In response, intent file processor 304 can extract the intent file from the package bundle (if not extracted already) (block 708) and can enter a loop for each mapping defined in the intent file (block 710). Within this loop, intent file processor 304 can check whether the old location of the application file corresponding to this mapping in build directory 110 is the same as the new location of the application file within install directory 122 (block 712). If so, no action needs to be taken and intent file processor 304 can proceed to the end of the current loop iteration (block 714).

However, if the old and new locations are not the same (indicating that the relative location of the application file has moved), intent file processor 304 can create, within install directory 122, a hard link for the application file at the old location that points to the actual, installed application file at the new location (block 716). For example, if file “level1.txt” resided under “main\assets” in build directory 110 but moved to “assets” in install directory 122, intent file processor 304 can create a hard link “main\assets\level1.txt” in install directory 122 that points to the actual file “assets\level1.txt” in install directory 122. This hard link can be thought of as a placeholder that can be accessed like a real file, but simply links to a file that exists elsewhere.

Upon creating the hard link, intent file processor can reach the end of the current loop iteration (block 714) and return to block 708 to process additional mappings in the intent file. Once all of the mappings have been processed workflow 700 can end.

### 5. Computer System Architecture

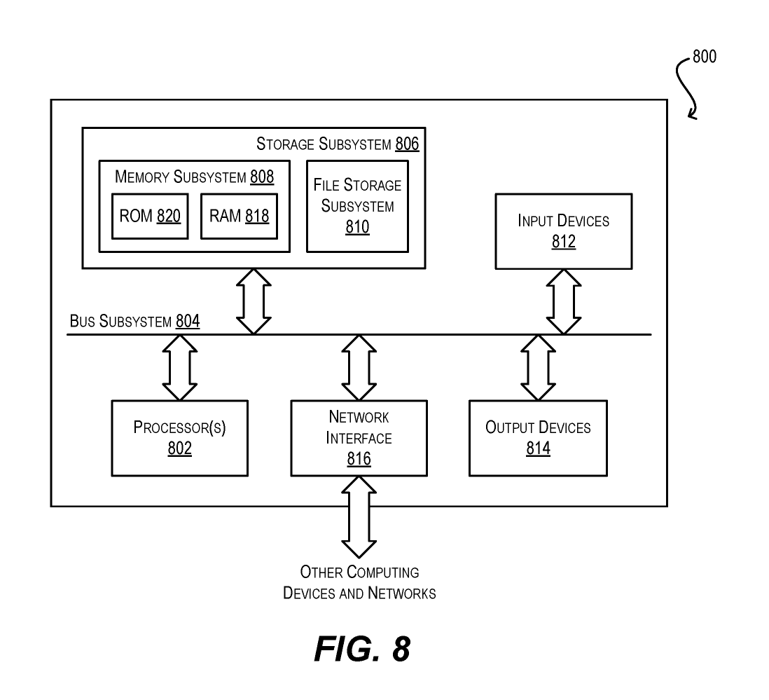

FIG. 8 is a simplified block diagram illustrating the architecture of an example computer system 800 according to certain embodiments. Computer system 800 (and/or equivalent systems/devices) may be used to implement any of the systems described in the foregoing disclosure. As shown in FIG. 8, computer system 800 includes one or more processors 802 that communicate with a number of peripheral devices via a bus subsystem 804. These peripheral devices include a storage subsystem 806 (comprising a memory subsystem 808 and a file storage subsystem 810), user interface input devices 812, user interface output devices 814, and a network interface subsystem 816.

Bus subsystem 804 can provide a mechanism for letting the various components and subsystems of computer system 800 communicate with each other as intended. Although bus subsystem 804 is shown schematically as a single bus, alternative embodiments of the bus subsystem can utilize multiple busses.

Network interface subsystem 816 can serve as an interface for communicating data between computer system 800 and other computer systems or networks. Embodiments of network interface subsystem 816 can include, e.g., an Ethernet module, a Wi-Fi and/or cellular connectivity module, and/or the like.

User interface input devices 812 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 800.

User interface output devices 814 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 800.

Storage subsystem 806 includes a memory subsystem 808 and a file/disk storage subsystem 810. Subsystems 808 and 810 represent non-transitory computer-readable storage media that can store program code and/or data that provide the functionality of embodiments of the present disclosure.

Memory subsystem 808 includes a number of memories including a main random access memory (RAM) 818 for storage of instructions and data during program execution and a read-only memory (ROM) 820 in which fixed instructions are stored. File storage subsystem 810 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of storage media known in the art.

It should be appreciated that computer system 800 is illustrative and other configurations having more or fewer components than computer system 800 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to, at a time of installing an application on the computer system:
extract an intent file from a software package comprising at least one file of the application, the intent file including a mapping that identifies a first location for the file with respect to a build directory of a development environment where the application was developed and a second location for the file with respect to an install directory of the computer system where the application will be installed; and
if the first location is different from the second location, create a hard link for the file at the first location within the install directory that points to an instance of the file residing at the second location within the install directory.

2. The computer system of claim 1 wherein the first and second locations are relative file paths within the build directory the install directory respectively.

3. The computer system of claim 1 wherein the intent file is generated by a packaging tool configured to create the software package from the build directory based on a set of packaging rules.

4. The computer system of claim 3 wherein the mapping is automatically determined by the packaging tool in view of the set of packaging rules.

5. The computer system of claim 3 wherein the mapping is provided to the packaging tool by an individual.

6. The computer system of claim 1 wherein the program code further causes the processor to, at a time of running the application:
access the file by accessing the hard link for the file at the first location within the install directory.

7. The computer system of claim 6 wherein the software package is an APPX package.

8. A method performed by a computer system at a time of installing an application, the method comprising:
extracting, by the computer system, an intent file from a software package comprising at least one file of the application, the intent file including a mapping that identifies a first location for the file with respect to a build directory of a development environment where the application was developed and a second location for the file with respect to an install directory of the computer system where the application will be installed; and
if the first location is different from the second location, creating, by the computer system, a hard link for the file at the first location within the install directory that points to an instance of the file residing at the second location within the install directory.

9. The method of claim 8 wherein the first and second locations are relative file paths within the build directory the install directory respectively.

10. The method of claim 8 wherein the intent file is generated by a packaging tool configured to create the software package from the build directory based on a set of packaging rules.

11. The method of claim 10 wherein the mapping is automatically determined by the packaging tool in view of the set of packaging rules.

12. The method of claim 10 wherein the mapping is provided to the packaging tool by an individual.

13. The method of claim 8 further comprising, at a time of running the application:
accessing the file by accessing the hard link for the file at the first location within the install directory.

14. The method of claim 8 wherein the software package is an APPX package.

15. A computer readable storage medium having stored thereon program code executable by a computer system, the program code causing the computer system to:
extract an intent file from a software package comprising at least one file of the application, the intent file including a mapping that identifies a first location for the file with respect to a build directory of a development environment where the application was developed and a second location for the file with respect to an install directory of the computer system where the application will be installed; and
if the first location is different from the second location, create a hard link for the file at the first location within the install directory that points to an instance of the file residing at the second location within the install directory.

16. The computer readable storage medium of claim 15 wherein the first and second locations are relative file paths within the build directory the install directory respectively.

17. The computer readable storage medium of claim 15 wherein the intent file is generated by a packaging tool configured to create the software package from the build directory based on a set of packaging rules.

18. The computer readable storage medium of claim 17 wherein the mapping is automatically determined by the packaging tool in view of the set of packaging rules.

19. The computer readable storage medium 17 wherein the mapping is provided to the packaging tool by an individual.

20. The computer readable storage medium of claim 15 wherein the program code further causes the computer system to, at a time of running the application:
access the file by accessing the hard link for the file at the first location within the install directory.
